(19) United States
(12) Patent Application Publication
(10) Pub. No.: US 2015/0292791 A1
(43) Pub. Date: Oct. 15, 2015

(54) COMPRESSOR MOUNTING BASE PLATE

(71) Applicant: DOW GLOBAL TECHNOLOGIES LLC, Midland, MI (US)

(72) Inventors: Ashishkumar S. Lokhande, Pune (IN); Onkareshwar V. Bijjargi, Pune (IN); Nilesh R. Tawde, Mumbai (IN); Gulab N. Malunjkar, Pune (IN); Paolo Diena, Modena (IT)

(73) Assignees: Dow Italia s.r.l., Milan (IT); Dow Chemical International PVT. LTD., Vikhroli (west) (IN); The Dow Chemical Company, Midland, MI (US)

(21) Appl. No.: 14/439,844

(22) PCT Filed: Nov. 20, 2013
(86) PCT No.: PCT/US2013/070884

§ 371 Date: Apr. 30, 2015

(30) Foreign Application Priority Data
Nov. 23, 2012 (IN) 4897/CHE/2012

(51) Int. Cl. F25D 23/00; F16M 5/00

(52) U.S. Cl. CPC F25D 23/006; F16M 5/00

(57) ABSTRACT

An elongated non-metal, non corrosive compressor mounting base plate structure including: (I) a base plate (40) segment having a top surface and a bottom surface, said base plate segment further comprising four vertical sidewalls (54) disposed perpendicular to the horizontal plane of the base plate and integral with the base plate segment, one vertical sidewall disposed on each of the four sides of the base plate segment and along the perimeter of the top surface of the base plate segment forming a base plate tray member; wherein the base plate segment is adapted for receiving a compressor on the top surface of the base plate segment within the area of the base plate segment surrounded by the four vertical sidewalls; (II) a means (56) for receiving and removably affixing a compressor to the top surface of the base plate segment; and (III) a reinforcement means integral with said base plate segment; wherein said reinforcement means includes at least two elongated transverse reinforcement segments integral with the base plate segment, one transverse reinforcement segment at each of the transverse sides of the base plate segment; said reinforcement means being adapted for providing the compressor mounting base plate structure with sufficient strength and rigidity such that the compressor mounting base plate structure can withstand deformation a load from the weight of the compressor; and wherein the compressor mounting base plate structure comprises a non-metal, non corrosive structure. In an optional preferred embodiment, the above compressor mounting base plate structure may include (IV) at least one load bearing/load distributing structure; (V) a drip tray member which can be integrally or removably attached to the above compressor mounting base plate; and/or (VI) a repositioning means such as wheel members.

### FIELD

The present invention relates to a compressor mounting base plate for an appliance; and a process for manufacturing the compressor mounting base plate. The present invention also relates to an appliance such as a refrigerator installed with the above compressor mounting base plate for a compressor to be mounted thereon.

### BACKGROUND

Original equipment manufacturers (OEMs) that manufacture refrigerators are aspiring to shift from the OEMs' current convention design practice of steel stamped refrigerator parts to new technologies in designing and manufacturing of such refrigerator parts. The current trend in the home appliance industry is moving toward a wall-mounted refrigerator which will prompt OEMs to make such products lighter. For example, OEMs are looking to replace the current steel compressor mounting plate (which is 1-2 kg in weight) of a current refrigerator with a light weight and a non-corrosive composite material compressor mounting base plate.

Generally, the lower portion or bottom structure of an appliance such as a refrigerator contains a machine compartment of the refrigerator, a compressor, and a compressor mounting base plate for attaching the compressor to the base plate. A compressor mounting base plate is positioned under the rear part of the refrigerator bottom so as to define a machine compartment and the compressor mounting base plate supports a compressor mounted on the base plate located in the machine compartment.

FIGS. 1 and 2 show a conventional design of a refrigerator, generally indicated by numeral 10, illustrating some of the conventional parts of a refrigerator including a conventional steel compressor mounting base plate 11 affixed to the bottom portion of the refrigerator cabin 12 at a lower portion of a refrigerator cabin; and a conventional compressor 13 affixed to the top surface of the compressor mounting base plate 11. The compressor 13 is attached to the top surface of the compressor mounting base plate 11 via threaded bolts 14 and threaded nuts 15; and compressor support member brackets 16 attached to the compressor 13. Disposed in-between the brackets 16 and the surface of the compressor mounting base plate 11 are vibration damping members 17 for attenuating the vibrations of the compressor when the compressor is in operation. In addition, wheels 18 are attached to the compressor mounting base plate 11 to provide movement of the refrigerator when the compressor mounting base plate 11 is affixed to the refrigerator cabin 12.

FIGS. 3-5 illustrate another example of a conventional steel compressor mounting base plate in the form of a rectangular-shaped tray member generally indicated by numeral 20 which can be affixed to the bottom portion of a refrigerator unit of the prior art (not shown) and which is also adapted for receiving and affixing a conventional compressor (not shown) thereto.

A typical compressor mounting plate of the prior art as shown in FIGS. 3-5 is made from 1 millimeter (mm) thick steel sheets. The compressor mounting plate is usually manufactured using a sheet metal stamping process to form a compressor mounting base plate 21 having a top surface 22 and a bottom surface 23. Integral with the base plate 21 are longitudinal sidewalls 24 and transverse sidewalls 25 forming a tray member 20. A secondary operation is typically used to form flange tabs 26, flange holes 27, orifices 28, and orifices 29 in the sheet (see FIGS. 3 and 4). Typically, the finished steel compressor mounting plate part is about 1.2 kilograms (kg) in weight.

The compressor mounting base plate 21 contains a plurality of orifices, typically four orifices 29, for receiving a threaded bolt 31 and a threaded nut 32 (for purposes of illustration, one orifice 29 is shown in FIGS. 3 and 4 without nuts and bolts). The threaded bolts 31 and nuts 32 are used to affix the compressor to the compressor mounting base plate 21. A rubber damper member 33, shown in FIGS. 3-5, is inserted between the bolt and nut for providing damping during operation of the compressor. The compressor is attached to the top surface 22 of the base plate to attach to the compressor mounting base plate via a bracket member (similar to bracket 16 of FIGS. 1 and 2). Wheels 34 rotatably affixed to the compressor mounting base plate 21 are used to install the compressor mounting base plate into the refrigerator unit.

When the steel compressor mounting plate of the prior art is subjected to a corrosive environment, over time, the conventional steel compressor mounting plate corrodes and loses its strength. Also, the structural damping coefficient for steel is approximately 2 percent (%) which causes vibrations to transfer to the refrigerator cabin through the compressor mounting plate even though there are typically four rubber dampers 33 fixed with the bolts 31 and nuts 32 on the steel sheet (see FIGS. 3-5) below the location of where the compressor support member brackets will be positioned (see brackets 16 of FIGS. 1 and 2).

Thus, OEMs in the home appliance industry are continually seeking appliance equipment and parts such as a compressor mounting base plate product for a refrigerator unit that would provide an improvement to the overall manufacturing and cost of an appliance such as a refrigerator unit.

### SUMMARY

The present invention includes a compressor mounting base plate design for an appliance device which uses a compressor, a motor, or an equivalent vibrating (reciprocating/rotating) apparatus such as a washing machine, a dishwasher, an air-conditioning unit, or a refrigerator unit. The compressor mounting plate exhibits beneficial characteristics which can also be critical customer requirements. For example, the compressor mounting base plate of the present invention can be light weight such that the compressor mounting base plate is from about 20% to 30% lighter than a steel plate. The compressor mounting base plate of the present invention also can be advantageously manufactured from a non-metal, non-corrosive composite material such as for example a polyurethane polymer.

In one embodiment, the compressor mounting base plate of the present invention includes an elongated non-metal, non-corrosive compressor mounting base plate structure for a refrigerator unit including the following elements:

(I) a base plate segment having a top surface and a bottom surface, wherein the base plate is integral with four sidewalls on the perimeter of the top surface of the base plate forming a base plate tray member; wherein the base plate segment is adapted for receiving a compressor on the top surface of the base plate segment;

(II) a means for receiving and removably affixing a compressor to the top surface of the base plate segment; and

(III) a reinforcement means integral with said base plate segment; wherein said reinforcement means includes at least two elongated transverse reinforcement segments integral with the base plate segment, one transverse reinforcement segment at each of the transverse sides of the base plate segment; said reinforcement means being adapted for providing the compressor mounting base plate structure with sufficient strength and rigidity such that the compressor mounting base plate structure can withstand a deformation load from the weight of the compressor; and wherein the compressor mounting base plate structure comprises a non-metal, non corrosive structure.

In another embodiment, the compressor mounting base plate of the present invention may optionally include a means for receiving and retaining liquid condensation that may occur during operation of the compressor. For example, such means can include a condensation tray member; and the condensation tray member can either be integral with the compressor mounting base plate segment or the condensation tray member can be a separate tray member removably attached to the top surface of the base plate segment. The condensation tray member can also be referred to as a drip tray. When the drip tray is employed in the present invention, for example, the drip tray can be located under the machine compartment of a refrigerator and designed for receiving and retaining water that might drip off an evaporator in the refrigerator.

Still another embodiment of the present invention includes a process for manufacturing the compressor mounting base plate. In one preferred embodiment for example, the process for manufacturing the compressor mounting base plate may include a Structural Reaction Injection Molding (S-RIM) process.

The composite-based compressor mounting base plate of the present invention has several advantages over a conventional steel-based compressor mounting base plate. For example, the composite-based compressor mounting base plate product of the present invention: (1) is light weight and up to 30% lighter in weight compared to a steel compressor mounting base plate; (2) is strong as a steel compressor mounting base plate; (3) exhibits no corrosion because the composite-based compressor mounting base plate of the present invention is made of a non-corrosive material such as a polyurethane polymer; (4) exhibits improved dynamic response under compressor loading conditions which is beneficial to restrict mechanical vibrations of the compressor during operation in an appliance device such as a refrigerator; and (5) is easily integrated into conventional parts of various appliance devices such as a conventional refrigerator.

In addition, one of the advantages of using the process of the present invention to manufacture a composite-based compressor mounting base plate over a steel-based compressor mounting base plate is that the process allows a manufacturer to make a product that can be made with low tooling cost and low manufacturing process cost in an attempt to reduce part cost.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings. In the following Figures, like numbers are used to indicate like elements in the Figures.

FIG. 1 is a perspective view of a back side lower portion of a refrigerator of the prior art showing some of the parts of a refrigerator including a machine compartment of a refrigerator containing a steel compressor mounting plate of the prior art installed in the lower portion of the refrigerator, and a compressor of the prior art mounted on the steel compressor mounting plate.

FIG. 2 is a front view of the back side lower portion of the refrigerator of FIG. 1 showing the machine compartment of the refrigerator according to the conventional art.

FIG. 3 is a perspective view of another embodiment of a steel compressor mounting plate of the prior art adapted to being installed in a refrigerator.

FIG. 4 is a top view of the prior art steel compressor mounting plate of FIG. 3.

FIG. 5 is a cross-sectional view of the prior art steel compressor mounting plate taken along line 5-5 of FIG. 4.

FIG. 6 is a perspective view of one embodiment of a compressor mounting plate of the present invention.

FIG. 7 is a cross-sectional view taken along line 7-7 of FIG. 6.

FIG. 8 is an enlarged cross-sectional view of a portion of one end of the compressor mounting base plate of FIG. 7.

FIG. 9 is a perspective view of another embodiment of a compressor mounting base plate of the present invention.

FIG. 10 is a cross-sectional view taken along line 10-10 of FIG. 9.

FIG. 11 is a cross-sectional partially exploded view of another embodiment of a compressor mounting base plate of the present invention.

FIG. 12 is a cross-sectional partially exploded view of another embodiment of a compressor mounting base plate of the present invention.

FIG. 13 is a perspective view of another embodiment of a compressor mounting base plate of the present invention.

FIG. 14 is a top view of the compressor mounting base plate of FIG. 13.

FIG. 15 is a cross-sectional view taken along line 15-15 of FIG. 14.

FIG. 16 is an enlarged cross-sectional view of a portion of one end of the compressor mounting base plate of FIG. 15.

FIG. 17 is a cross-sectional view taken along line 17-17 of FIG. 14.

FIG. 18 is a cross-sectional view taken along line 18-18 of FIG. 14.

FIG. 19 is a cross-sectional view of another embodiment of a compressor mounting base plate of the present invention.

### DETAILED DESCRIPTION

“Light weight”, with reference to a composite compressor base plate, herein means a reduced mass of the composite compressor base plate compared to a conventional steel base plate.

“Dynamic response”, with reference to a compressor base plate, herein means the required dynamic stiffness of the compressor base plate sufficient for the compressor base plate to sustain and to isolate vibration of a compressor while providing the required stiffness of the compressor base plate sufficient for the compressor base plate's operation.

“Strong”, with reference to a compressor base plate, means the required static stiffness of the compressor base plate sufficient for the compressor base plate to contain/withstand the mass and weight of a compressor.

The present invention has been discovered keeping in mind the above problems occurring in the prior art.

A compressor, used in for example appliance devices such as refrigerator units, is an apparatus for compressing a low temperature/low pressure refrigerant into a high temperature/high pressure refrigerant and discharging the high temperature/high pressure refrigerant therefrom. After the discharged refrigerant is heat-radiated to an atmosphere and is changed into the low temperature/low pressure refrigerant via an expansion unit, the low temperature/low pressure refrigerant absorbs heat from an inside of the refrigerator unit.

While the compressor is operated, vibration is generated from the compressor; and the generated vibration is transmitted to other elements of the appliance device connected to the compressor without damping, thereby causing a noisy vibration to be generated from the whole of the device through each element of the device connected to the compressor. Therefore, one objective of the present invention is to provide a compressor mounting base plate structure that advantageously prevents, reduces or attenuates the transmittance of the vibration generated from the compressor through the compressor mounting base plate structure supporting the compressor and to the other elements of an appliance device such as a refrigerator main body and frame.

A compressor, used in appliance devices such as refrigerators, also commonly operates in a corrosive environment due to the moisture created by condensation in the machine room where the compressor is located. Therefore, another object of the present invention is to provide a compressor mounting base plate structure for a refrigerator that is made of a non corrosive synthetic resin material.

Another object of the present invention is to provide a compressor mounting base plate structure that is sufficiently strong and capable of taking the load conditions of a compressor; thus, preventing deformation of the surface of the compressor mounting base plate when a relatively heavy compressor is affixed to the compressor mounting base plate.

Since the lower portion of a conventional refrigerator is made of metal and a conventional compressor is made of metal, the total weight of the refrigerator with a compressor is heavy, and the manufacturing cost of the refrigerator is high. Therefore, a further object of the present invention is to provide a composite-based compressor mounting base plate structure that is light weight by fabricating the compressor mounting base plate structure with a composite material; and thus, reducing the weight of the compressor mounting base plate structure and the overall weight of an appliance device incorporating such a light weight compressor mounting base plate structure.

Another object of the present invention is to simplify the fabrication of the compressor mounting base plate structure. Therefore, a simpler process is provided to produce a single piece compressor mounting base plate structure wherein the fabrication costs for manufacturing the compressor mounting base plate structure is reduced; and ultimately so that the costs of an appliance device incorporating such compressor mounting base plate structure is also reduced.

To achieve the above objects, the present invention provides a composite-based compressor mounting base plate structure for appliance devices such as refrigerators, wherein said compressor mounting base plate structure is made of a synthetic resin material utilizing for example a structural reaction injection molding process.

Another object of the present invention is to provide a simplified composite-based compressor mounting base plate structure that compliments other parts of equipment in an appliance device, thereby reducing manufacturing cost and improving assembly efficiency.

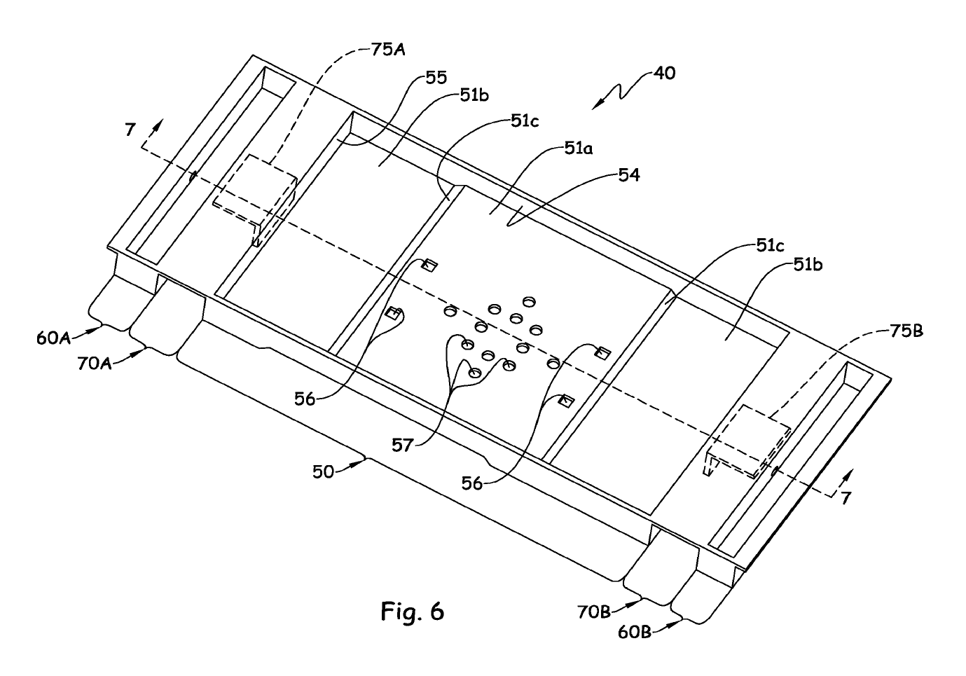

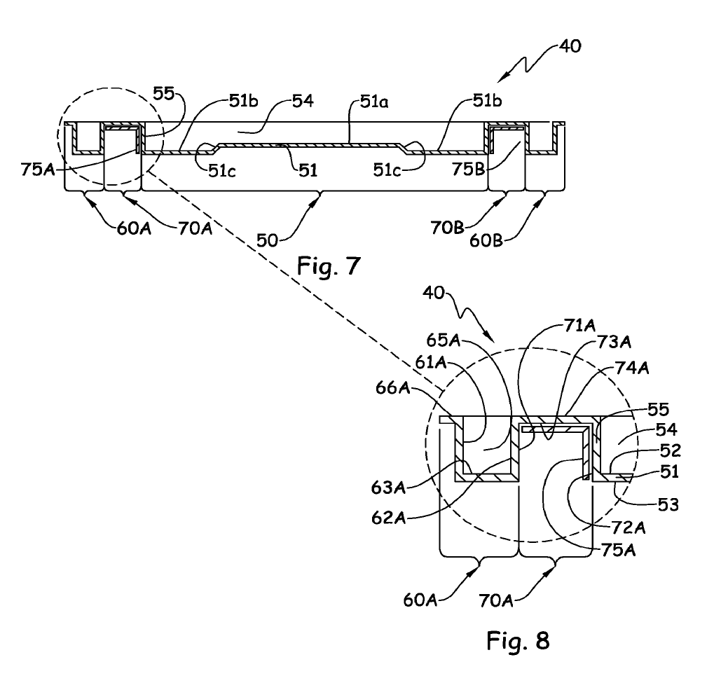

With reference to FIGS. 6-8, there is shown one embodiment of a compressor mounting base plate structure of the present invention comprising an elongated, non-metal, non corrosive, compressor mounting base plate structure which is generally planar and generally rectangular in shape (herein referred to as “the base plate”). The base plate of the present invention, shown in FIGS. 6-8, is generally indicated by reference numeral 40.

The base plate 40 includes an integral combination of a middle or central base plate section or segment, generally indicated by numeral 50; a structural reinforcement means comprising a first and second reinforcing sections generally indicated by numerals 60A and 60B, respectively; and a first and second repositioning structural means 70A and 70B, respectively. In the embodiment shown in FIGS. 6-8, the base plate segment 50 is generally planar and generally rectangular in shape with two opposite longitudinal sides parallel to each other and two opposite transverse sides parallel to each other forming the four sides of the generally rectangular shaped base plate segment 50. However, the shape of the planar base plate segment 50 is not limited to a rectangular shape and can be other shapes such as trapezoidal.

The first and second reinforcing sections 60A and 60B are integrally connected to the base plate segment 50 and are generally transverse to the longitudinal horizontal plane of the base plate segment 50. The structural reinforcement means made up of the first and second transverse reinforcing sections 60A and 60B are adapted to provide reinforcement for the base plate 40. For example, the first and second transverse reinforcing sections 60A and 60B are adapted for providing the base plate 40 with increased strength and rigidity such that the base plate 40 can withstand deformation load from the heavy weight of a compressor.

The first and second transverse reinforcing sections 60A and 60B are also integrally connected to the first and second repositioning structural means 70A and 70B, respectively, for receiving and removably affixing wheel members (not shown) to the base plate 40. The first and second repositioning structural means 70A and 70B, respectively, are also generally transverse to the longitudinal horizontal plane of the base plate segment 50. Other optional supplemental structural reinforcement means may be integrally connected to the base plate segment 50 and/or integrally connected to the reinforcing sections 60A and 60B as described herein.

With reference to FIGS. 6-8 again, there is shown one embodiment of a base plate 40, useful for an appliance device such as a refrigerator unit, including the elongated, generally planar and generally rectangular shaped non-metal, non-corrosive compressor mounting base plate segment 50 made of, for example, a polyurethane resin composite material.

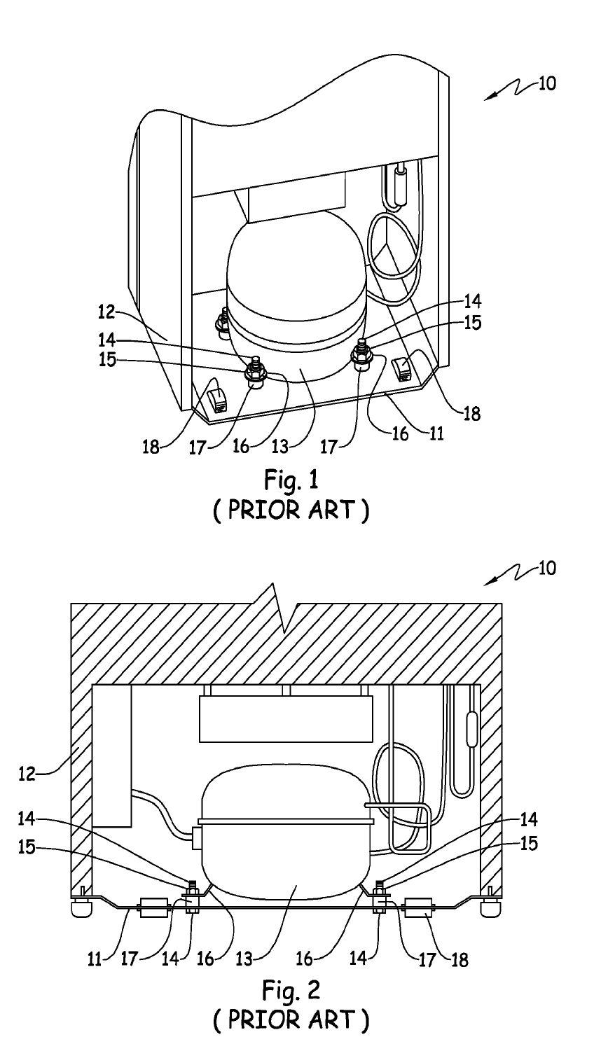

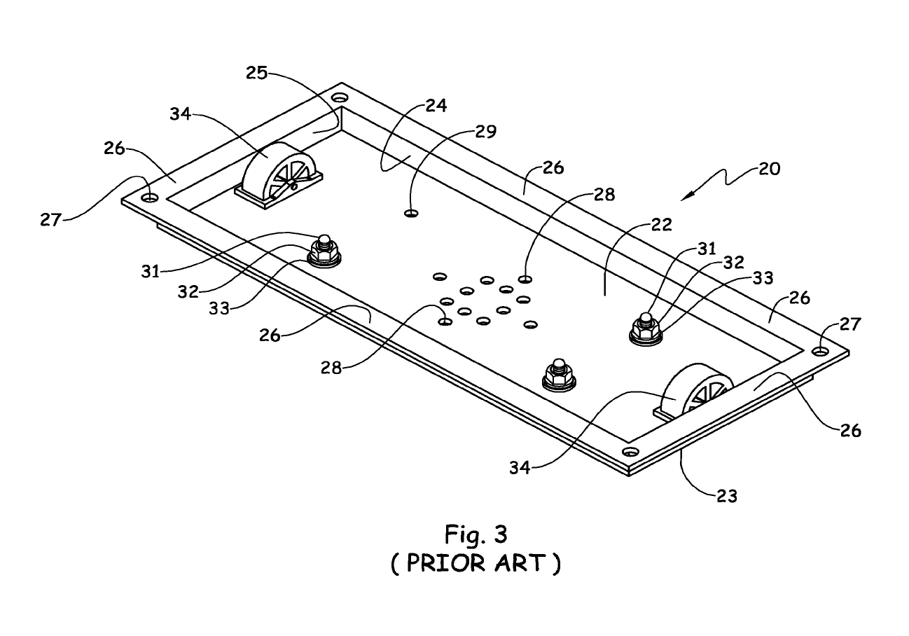

The base plate segment 50 of the base plate 40 is adapted for receiving and removably affixing a compressor (not shown in FIGS. 6-8, however, the compressor of the present invention may be similar to a conventional compressor 13 shown in FIGS. 1 and 2) to the base plate segment 50. The base plate segment 50, as shown in FIGS. 6-8, generally includes a flat or substantially planar base plate segment member 51 having a top surface 52 and a bottom surface 53. In addition, the base plate segment member 51 includes vertical sidewall members 54, one vertical sidewall member 54 on each one of the longitudinal elongated sides of the base plate segment member 51, and vertical sidewall members 55, one vertical sidewall member 55 on each one of the transverse sides of the base plate segment member 51. The sidewall members 54 and 55 are integral with the planar base plate segment member 51 on the perimeter of the top surface 52 of the base plate segment member 51 forming a generally rectangular-shaped base plate segment 50 having the integral vertical sidewall members 54 and 55 around the perimeter or circumference of the base plate segment member 51 to form a base plate tray member (or pan member) 50.

Although the base plate segment member 51 and the base plate segment 50 are shown generally as a rectangular-shaped member, the shape of the base plate segment member 51 and the base plate segment 50 are not limited to a rectangular shape, but may include any shape desired that meets the requirements for an appliance device. For example, the shape of the base plate segment member 51 and the base plate segment 50 can include an oval, triangle, pyramid, square, and the like.

Generally, the vertical sidewall members 54 and 55 have a vertical plane that is perpendicular to the horizontal plane of the top surface 52 of the base plate segment member 51 such that base plate tray member 50 is formed wherein the top portion 52 of the base plate segment member 51 forms the bottom portion 52 of the base plate tray member 50. The top portion 52 or the mouth of the base plate tray member 50 is disposed perpendicular to the horizontal plane of the base plate segment member 51 such that the mouth of the base plate tray member 50 is adapted for receiving a compressor.

The base plate segment 50 is adapted for receiving the compressor, via one or more orifices 56 disposed through the body of the planar base plate segment member 51, and is adapted for receiving a means for mounting/affixing a compressor to the top surface 52 of the planar base plate segment member 51. The means for affixing a compressor to the base plate segment member 51 may be generally disposed in the middle or central portion of the planar base plate segment member 51.

The base plate segment member 51 also includes orifices 57 to provide air circulation or air venting therethrough. The orifices 57 also provide heat dissipation present in the tray member 50. In one embodiment, the base plate segment member 51 can include one or more venting orifices 57, preferably a plurality of venting orifices 57, for allowing air to pass through the orifices 57 and circulate around the compressor for cooling the compressor and other equipment incorporated, for example, in a machine room of an appliance device such as a refrigerator.

FIGS. 6-8 show one embodiment of the base plate segment 50 including the planar base plate segment member 51 having a raised surface area portion 51a in the central area of the base plate segment member 51 protruding toward the top surface 52 of the base plate segment member 51 and two lower surface area portions 51b on the top surface 52 of the base plate segment member 51, one lower surface area portion 51b on each one of the transverse sides of the raised portion 51a and integral with the raised portion 51a via beveled edges 51c. The lower portions 51b are also integral with the sidewalls 54 and 55.

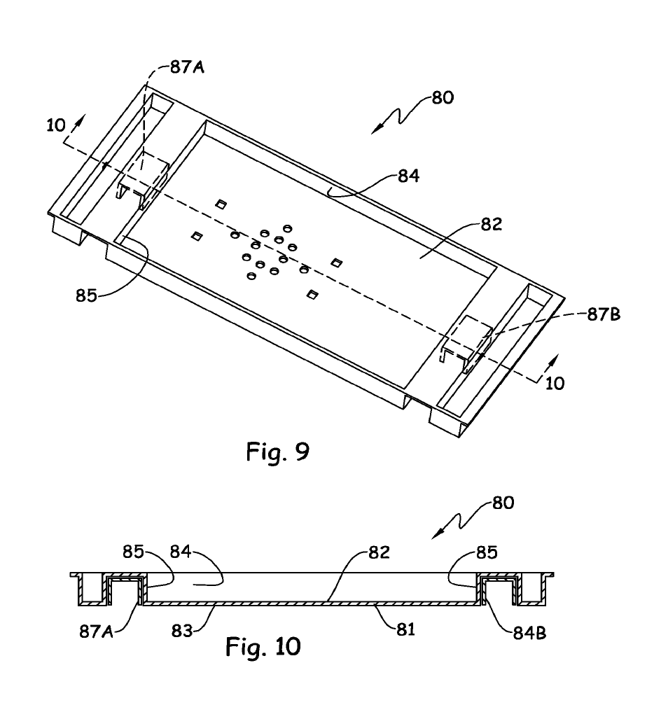

In another embodiment shown in FIGS. 9 and 10, a base plate 80 includes a planar base plate segment member 81 having a top surface 82 and bottom surface 83 and vertical sidewall members 84, one vertical sidewall member 84 on each one of the longitudinal elongated sides of the planar base plate segment member 81, and vertical sidewall members 85, one vertical sidewall member 85 on each one of the transverse sides of the planar base plate segment member 81; the vertical sidewalls 84 and 85 being integral with the base plate planar segment member 81. The top surface 82 of the planar base plate segment member 81, in this embodiment, is substantially level across the horizontal plane of the planar base plate segment member 81 without a raised portion protruding from the top surface 82 as shown in FIG. 10.

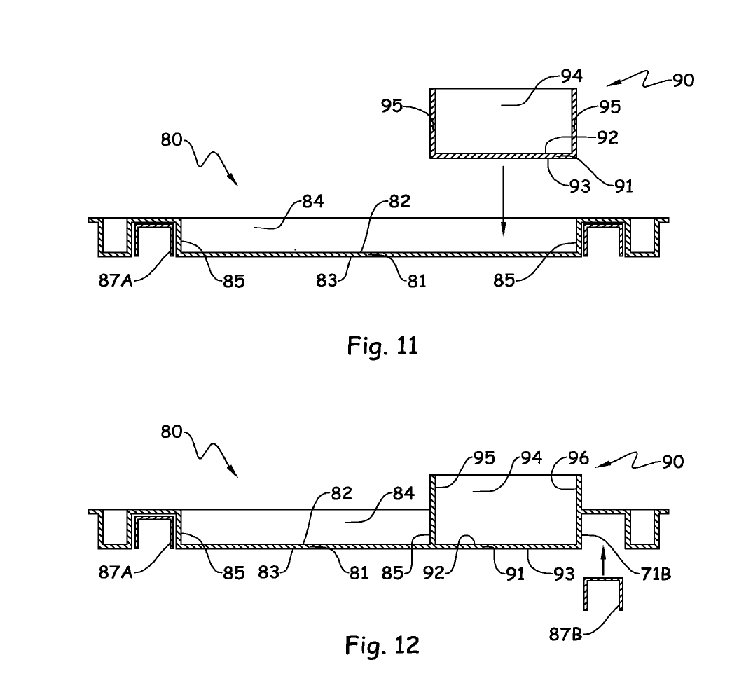

In still another embodiment, the compressor mounting base plate structure of the present invention may optionally include a means for receiving and retaining water that could possibly drip off equipment operating in an appliance device such as an evaporator typically found in a refrigerator. This optional means for receiving and retaining water will be referred to herein as a “drip tray”, and will be generally indicated by reference numeral 90 in FIGS. 11-12. The drip tray 90 is adapted for collecting a liquid or moisture, i.e., the drip tray 90 is used to capture and collect water formed through condensation or other liquid in the machine room of an appliance device such as a refrigerator unit.

In one embodiment shown in FIG. 11, the drip tray 90 may be first made as a separate drip tray member 90 and then the drip tray 90 can subsequently be removably or permanently attached to the top surface 82 of the planar base plate segment member 81 of the base plate 80 to incorporate the separate drip tray member into the overall structure of the base plate 80. For example as shown in FIG. 11, the drip tray 90 may comprise a bottom plate 91 having a top surface 92 and a bottom surface 93 and vertical sidewalls 94 and vertical sidewalls 95 along the perimeter of the top surface 92 of the bottom plate 91. The drip tray 90 can be attached, for example, with an adhesive or other attachment means to the top surface 82 of the base plate planar segment member 81 of the base plate 80 to form the configuration shown in FIG. 11.

In another embodiment, the drip tray 90 may be incorporated integrally with the base plate planar segment member 81 of the base plate 80. For example, with reference to FIG. 12, the drip tray 90 may comprises vertical sidewalls 94, 95, and 96 integral with the base plate planar segment member 81 of the base plate 80 on the top surface 82 of the base plate segment member 81 forming the bottom portion 92 of the drip tray member 90. The drip tray 90 can be made simultaneously and integrally with the base plate 80 during the fabrication process of the overall structure of the base plate 80. In the embodiment shown in FIG. 12, the vertical sidewalls 94 of the drip tray 90 are coterminous with vertical sidewall members 84 of base plate segment member 81, the vertical sidewall member 95 of the drip tray 90 is coterminous with the vertical sidewall member 86 of base plate segment member 81, a portion of the vertical sidewall member 96 of the drip tray 90 is coterminous with the vertical sidewall 72B of the repositioning structural means 70B and the bottom plate 91 of the drip tray 90 is coterminous with a portion of the planar base plate segment member 81.

The mouth of the drip tray 90 is disposed generally perpendicular to the horizontal plane of the base plate segment member 81; such that the drip tray 90 is adapted for receiving and retaining water that might drip off, for example, from an evaporator unit of a refrigerator unit.

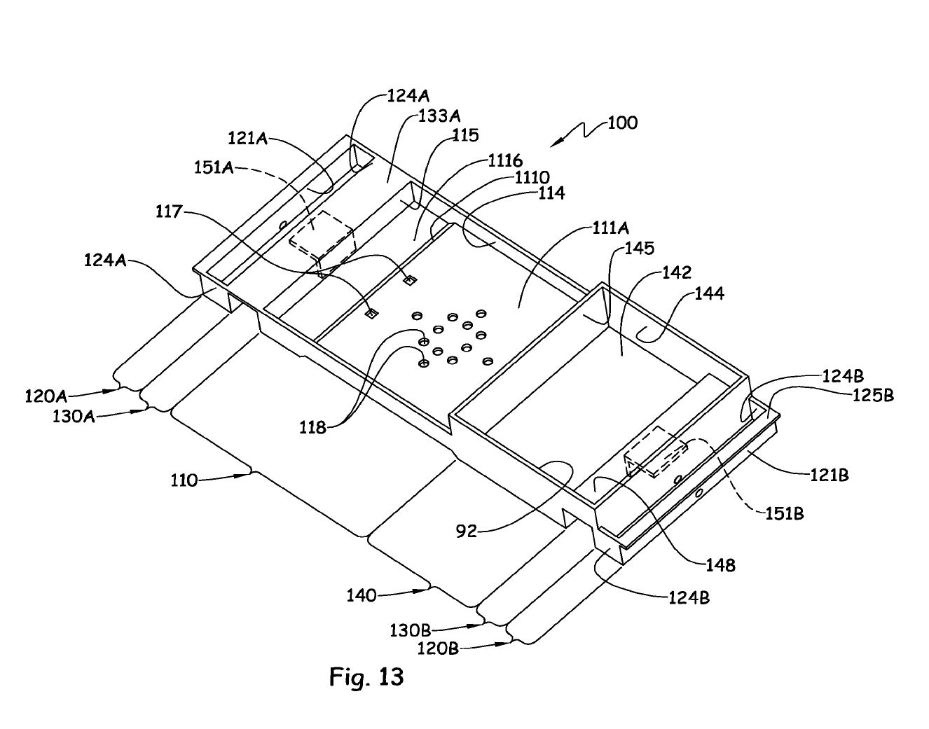

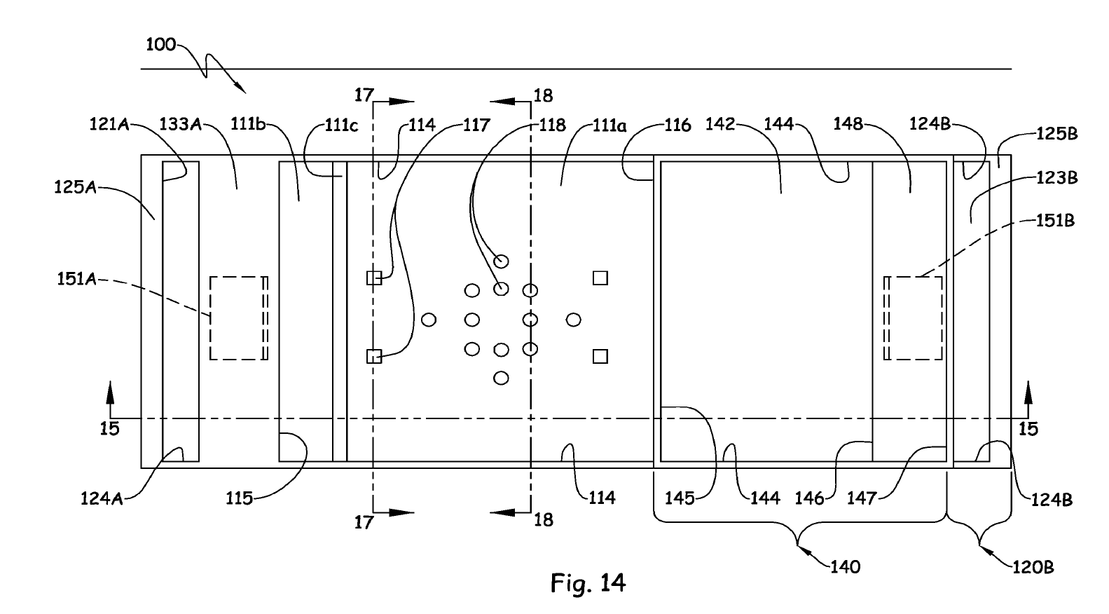

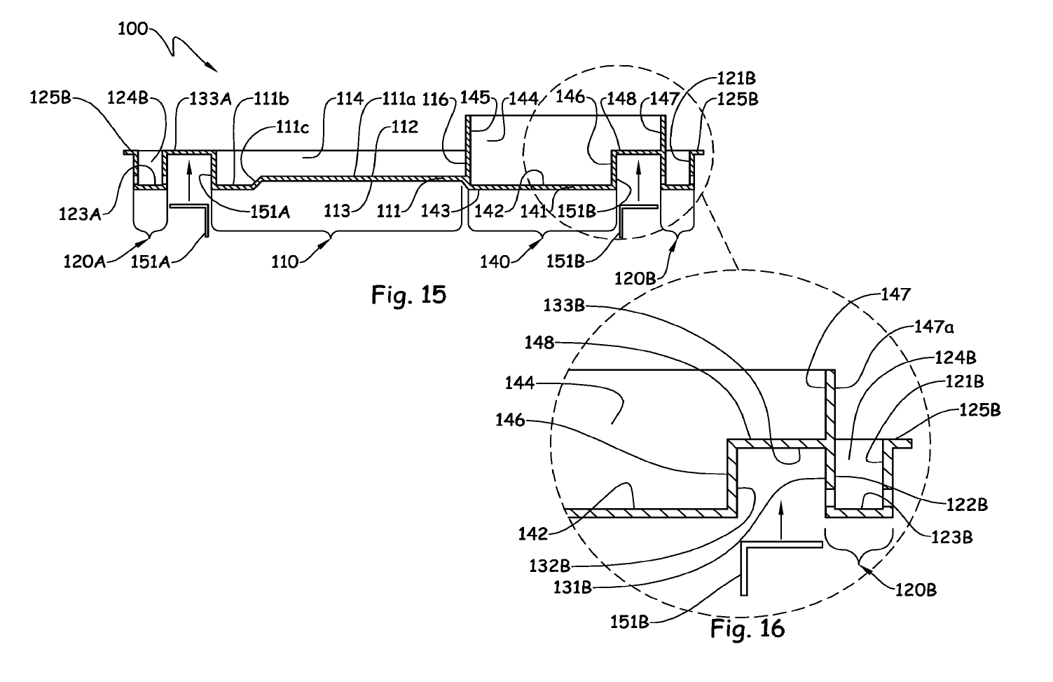

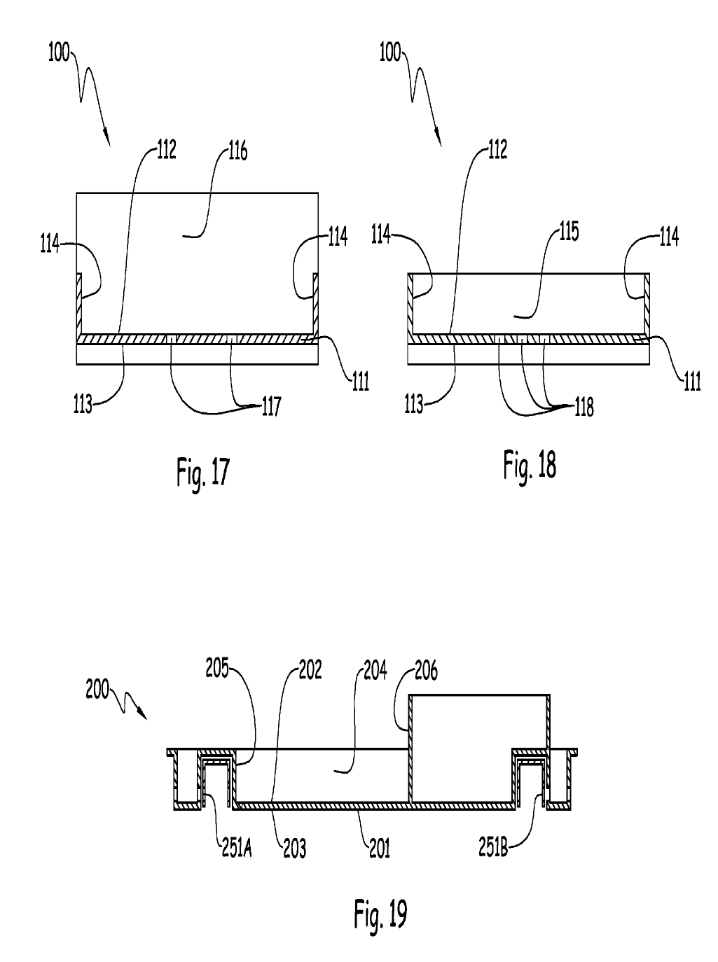

With reference to FIGS. 13-18, there is shown a preferred embodiment of a compressor mounting base plate of the present invention comprising an elongated, non-metal, non corrosive, compressor mounting base plate structure which is generally planar and generally rectangular in shape (referred to herein as “the base plate”). The base plate of the present invention, shown in FIGS. 13-18, is indicated generally by reference numeral 100.

The base plate 100 includes a combination of a middle or central base plate section or segment, generally indicated by numeral 110; a structural reinforcement means comprising a first and second reinforcing sections generally indicated by numerals 120A and 120B, respectively; and a first and second repositioning structural means 130A and 130B, respectively. In the embodiment shown in FIGS. 13-18, the base plate segment 100 is generally planar and generally rectangular in shape with two opposite longitudinal sides parallel to each other and two opposite transverse sides parallel to each other forming the four sides of the generally rectangular shaped base plate segment 100. However, the shape of the planar base plate segment 100 is not limited to a rectangular shape and can be other shapes such as trapezoidal.

The first and second reinforcing sections 120A and 120B are integrally connected to the base plate segment 110 and are generally transverse to the longitudinal horizontal plane of the base plate segment 110. The structural reinforcement means made up of the first and second reinforcing sections 120A and 120B are adapted to provide reinforcement for the base plate 100. For example, the first and second reinforcing sections 120A and 120B are adapted for providing the base plate 100 with increased strength and rigidity such that the base plate 100 can withstand deformation load from the heavy weight of a compressor.

The first and second transverse reinforcing sections 120A and 120B are also integrally connected to the first and second repositioning structural means 130A and 130B, respectively, for receiving and removably affixing wheel members (not shown) to the base plate 100. The first and second repositioning structural means 130A and 130B, respectively, are also generally transverse to the longitudinal horizontal plane of the base plate segment 110. Other optional supplemental structural reinforcement means may be integrally connected to the base plate segment 100 and/or integrally connected to the reinforcing sections 120A and 120B as described herein.

With reference to FIGS. 13-18 again, there is shown one embodiment of a base plate 100, useful for an appliance device such as a refrigerator unit, including the elongated, generally planar, non-metal, non-corrosive polyurethane composite compressor mounting base plate member segment 110.

The base plate segment 110 of the base plate 100 is adapted for receiving and removably affixing a compressor (although not shown in FIGS. 13-18, the compressor of the present invention may be similar to a conventional compressor 13 shown in FIGS. 1 and 2) to the base plate segment 110. The base plate segment 110, as shown in FIGS. 13-18, generally includes a flat or substantially planar base plate segment member 111 having a top surface 112 and a bottom surface 113. In addition, the base plate segment member 111 includes vertical longitudinal sidewall members 114, one vertical longitudinal sidewall 114 on each one of the longitudinal elongated sides of the base plate segment member 111, a vertical transverse sidewall member 115 on one of the transverse sides of the base plate segment member 111, and a vertical transverse sidewall member 116 on the other transverse side of the base plate segment member 111. The sidewalls 114, 115, and 116 are integral with the planar base plate segment member 111 on the perimeter of the top surface 112 of the base plate segment member 111 forming a generally rectangular-shaped base plate segment 110 having the integral vertical sidewall members 114, 115, and 116 around the perimeter or circumference of the base plate segment member 111 to form a base plate tray member (or pan member) 110.

Although the base plate segment member 111 and the base plate segment 110 are shown generally as a rectangular-shaped member, the shape of the base plate segment member 111 and the base plate segment 110 are not limited to a rectangular shape, but may include any shape desired that meets the requirements for an appliance device. For example, the shape of the base plate segment member 111 and the base plate segment 110 can include an oval, triangle, pyramid, square, and the like.

Generally, the vertical sidewalls 114, 115, and 116 have a vertical plane that is perpendicular to the horizontal plane of the top surface 112 of the base plate segment member 111 such that base plate segment 110 is formed wherein the top portion 112 of the base plate segment member 111 forms the bottom portion 112 of the base plate tray member 110. The top portion 112 or the mouth of the base plate tray member 110 is disposed perpendicular to the horizontal plane of the base plate segment member 111 such that the mouth of the base plate tray member 110 is adapted for receiving a compressor.

The base plate segment 110 is adapted for receiving the compressor, via one or more orifices 117 disposed through the body of the planar base plate segment member 111, and is adapted for receiving a means for mounting/affixing a compressor to the top surface 112 of the planar base plate segment member 111. The means for affixing a compressor to the base plate segment member 111 may be generally disposed in the middle or central portion of the planar base plate segment member 111.

The base plate segment member 111 also includes orifices 118 to provide air circulation or air venting therethrough. The orifices 118 also provide heat dissipation present in the tray member 100. In one embodiment, the base plate segment member 111 can include one or more venting orifices 118, preferably a plurality of venting orifices 118, for allowing air to pass through the orifices 118 and circulate around the compressor for cooling the compressor and other equipment incorporated, for example, in a machine room of an appliance device such as a refrigerator.

FIGS. 13-18 show one embodiment of the base plate segment 110 including the planar base plate segment member 111 having a raised surface area portion 111a in the central area of the base plate segment member 111 protruding toward the top surface 112 of the base plate segment member 111 and two lower surface area portions 111b on the top surface 112 of the base plate segment member 111, one lower surface area portion 111b on each one of the transverse sides of the raised portion 111a and integral with the raised portion 111a via beveled edges 111c. The lower portions 111b are also integral with the vertical sidewalls 114 and 115.

In another embodiment shown in FIG. 19, a base plate 200 includes a planar base plate segment member 201 having a top surface 202 and bottom surface 203 and vertical longitudinal sidewall members 204, one vertical longitudinal sidewall member 204 on each one of the longitudinal elongated sides of the planar base plate segment member 201, a vertical transverse sidewall member 205 on one of the transverse sides of the planar base plate segment member 201; and a vertical transverse sidewall member 206, on the other transverse side of the planar base plate segment member 201; the vertical transverse sidewall members 205 and 206 being integral with the vertical longitudinal sidewall members 204 and base plate segment member 201. The top surface 202 of the planar base plate segment member 201, in this embodiment, is substantially level across the horizontal plane of the planar base plate segment member 201 without a raised portion protruding from the top surface 202.

The top portion of the base plate 100 includes a means for receiving and removably affixing a compressor or a mounting means adapted for mounting/affixing a compressor member to the top surface 112 of the base plate segment member 111 generally in the central portion of the base plate segment member 111. The mounting means includes for example one or more orifices 117 for receiving a threaded bolt therethrough (although not shown in FIGS. 13-18, the threaded bolt of the present invention may be similar to the bolt 27 shown in FIG. 2). The threaded bolt is inserted in the orifice 117 from the bottom surface 113 of the base plate segment member 111 to the top surface 112 of the base plate segment member 111. The threaded nuts (although not shown in FIGS. 13-18, the threaded nut of the present invention may be similar to a conventional threaded nut 15 shown in FIGS. 1 and 2) are used for engaging the threaded bolt. The threaded nuts for the bolts are used to secure the compressor on the base plate via metal support mounting brackets (although not shown in FIGS. 13-18, the brackets of the present invention may be similar to brackets 16 shown in FIG. 2) attached to the compressor. Inserted in between the support brackets attached to the compressor and the base plate is a vibration damper member (although not shown in FIGS. 13-18, the damper member of the present invention may be similar to dampers 17 in FIG. 2), typically made of rubber, to dampen the vibrations caused by the operation of the compressor. The compressor (although not shown in FIGS. 13-18, the compressor of the present invention may be similar to compressor 13 shown in FIG. 2) can be removably affixed to the top surface 112 of the base plate segment member 111 via threaded nuts and bolts inserted through orifices 117 in the base plate segment member 111. When a heavy compressor is mounted on the base plate segment member 111, it is possible that a compressor-seating portion (not shown) of the base plate is made accommodate the weight of the compressor. For example the compressor-seating portion of the base plate can be made of a high strength synthetic resin.

In one embodiment, the base plate of the present invention can include at least one load bearing/load distributing structure adapted for providing strength, reinforcement and integrity to the mounting base plate structure integral with the base plate. For example, the load bearing/load distributing structure can be a raised surface area or section in at least a portion of the base plate segment member 111. In a preferred embodiment, shown in FIGS. 13-18, the base plate segment 110 includes the planar base plate segment member 111 having a raised portion 111a in the central area of the base plate segment member 111 and two lower portions 111b, one on each transverse side of the raised portion 111a and integral with the raised portion 111a via beveled edges 111c and wherein the lower portions 111b are integral with the vertical sidewalls 114-116 of the base plate segment member 111. The raised area 111a is adapted for receiving the compressor (not shown in FIGS. 13-18).

As aforementioned, the present invention includes a reinforcement means segment comprising of a first and second reinforcing sections generally indicated by numerals 120A and 120B, respectively. The reinforcement means integral with the base plate 100 advantageously provides the base plate 100 with increased strength and rigidity, which allows the base plate 100 to withstand deformation load from the weight of the compressor which said compressor is typically made of steel. The first reinforcing structure member 120A is preferably integral with the base plate 100 at one proximal end of the base plate 100; and the second reinforcing structure member 120B is preferably integral with the base plate 100 at one distal end of the base plate 100.

In the embodiment shown in FIGS. 13-18, the reinforcement means integral with the base plate 100 includes at least a first reinforcing structure member 120A integral with the base plate 100 at a proximal end of the base plate 100; and at least a second reinforcing structure member 120B integral with the base plate 100 at a distal end of the base plate 100. For example, the first and second reinforcing structure members 120A, 120B can comprise a channel member 120A, 120B respectively, integral with the base plate 100. In FIGS. 13-18, the channel members 120A, 120B are shown in a U-shaped configuration, when viewed in cross-section, but the channel members 120A, 120B are not limited to such U-shaped configuration. For example, the shape of the channel members, when viewed in cross-section can be V-shaped, trapezoidal shaped, and the like. In another optional embodiment, one reinforcing structure channel member 120A or 120B disposed at the proximal end of the base plate 100 can be of one shape and the other reinforcing structure channel member 120A or 120B disposed at the distal end of the base plate 100 can be of a different shape. In a preferred embodiment, both of the channels 120A, 120B for the first and second reinforcing structure members respectively, are U-shaped and can include sidewalls 125A and 125B at both ends of the U-shaped channels 120A and 120B respectively forming a first and second elongated transverse U-shaped trough members 120A and 120B respectively.

In addition, the base plate can include a ledge portion 126A on the outside rim perimeter of the first elongated U-shaped channel trough member 120A; and can include a ledge portion 126B on the outside rim perimeter of the second elongated U-shaped channel trough member 120B; wherein the ledge portions 126A and 126B, respectively, of the first and second elongated U-shaped channel trough members 120A and 120B, respectively, are adapted to contain means (not shown) for attaching the base plate 100 to the lower portion of an appliance device such as a refrigerator unit. In general, the means for attaching the base plate to the lower portion of an appliance device can be for example one or more orifices in the ledge portions 126A and 126B wherein a thread bolt can be inserted therethrough and a treaded nut for securing the bolt and base plate 100 to the appliance device.

In other embodiments, the first elongated U-shaped channel trough member 120A, the second elongated U-shaped channel trough member 120B, or both the first elongated U-shaped channel trough members 120A, 120B of the base plate 100, can comprise a solid elongated U-shaped bar or rib (not shown) integral with the base plate 100.

The compressor mounting base plate structure of the present invention of FIGS. 13-18 may optionally include a means for receiving and retaining water that could possibly drip off equipment operating in an appliance device such as an evaporator found in a refrigerator. This optional means for receiving and retaining water herein will be referred to as a “drip tray”, generally indicated by reference numeral 140 in FIGS. 13-18. The drip tray 140 is adapted for collecting a liquid, i.e., the drip tray 140 is used to capture and collect water formed through condensation or other liquid in the machine room of an appliance device such as a refrigerator unit.

Although not shown, in one embodiment, the drip tray 140 may be first manufactured as a separate and independent drip tray member (not shown) produced separately from the base plate 100. Then the separate drip tray can subsequently be removably or permanently attached to the top surface 112 of the base plate segment member 111 of the base plate 100 to incorporate the separate drip tray member into the overall structure of the base plate 100 of the present invention similar to the drip tray 90 shown in FIG. 11 as described above. The separate drip tray can be positioned on any part of the top surface 112 of the base plate segment member 111 such as for example at one distal end of the of base plate 100.

In another embodiment, the drip tray 140 may be integral with the base plate segment member 110 of the base plate 100 similar to the drip tray 90 shown in FIG. 12 as described above. In the embodiment shown in FIGS. 13-18, the drip tray 140 is designed to be integrally incorporated into the base plate 100. With reference to FIGS. 13-18, there is shown a drip tray 140 integrally made with the overall structure of the base plate segment member 111 including coterminous vertical sidewalls 144, 145, and 146 integral with the base plate 100 on the top surface 112 of the base plate segment member 111 forming the bottom surface area 142 of the drip tray 140. The mouth of the drip tray 140 is disposed generally perpendicular to the horizontal plane of the base plate segment member 111; and wherein the drip tray 140 is adapted for receiving and retaining water that might drip off for example an evaporator.

In the embodiment shown in FIGS. 13-18, the drip tray member 140 is integrally part of the overall compressor base plate 100 and an injection molding process can be advantageously used to form the overall base plate 100 including incorporating the drip tray 140. This preferred method of manufacturing the base plate 100 is a simplified and cost effective process. The drip tray 140 can be positioned on any part of the top surface 112 of the base plate segment member 111 such as for example at one distal end of the of base plate 100.

The compressor mounting base plate structure of the present invention can include a repositioning structure means removably attached to the base plate structure. The repositioning means is adapted for moving the base plate to and from a lower portion of an appliance device such as a refrigerator unit during installation of the base plate to the refrigerator unit. In addition, the repositioning means is adapted for moving the refrigerator unit from one location to another location once the base plate is affixed to the lower portion of the refrigerator unit. In other words, once the base plate 100 is affixed to the lower portion of the refrigerator unit, the repositioning structure means, via the base plate 100, can be adapted for moving the refrigerator unit from one position to another during installation of the refrigerator unit in a location.

The repositioning means can include, for example, (1) a first inverted U-shaped channel (or tunnel-like member) 130A, when viewed in cross-section, disposed in-between the base plate segment member 111 and the first reinforcing structure 120A and generally transverse to the longitudinal horizontal plane of the base plate segment member 111. The inverted U-shaped structure 130A is integral with the base plate segment member 111 and the first reinforcing structure 120A. The repositioning means also can include, for example, (2) a second inverted U-shaped channel (or tunnel-like member) 130B, when viewed in cross-section, disposed in-between the base plate segment member 111 and the second reinforcing structure 120B and generally transverse to the longitudinal horizontal plane of the base plate segment member 111. The inverted U-shaped structure 130B is integral with the base plate segment member 111 and the second reinforcing structure 120B.

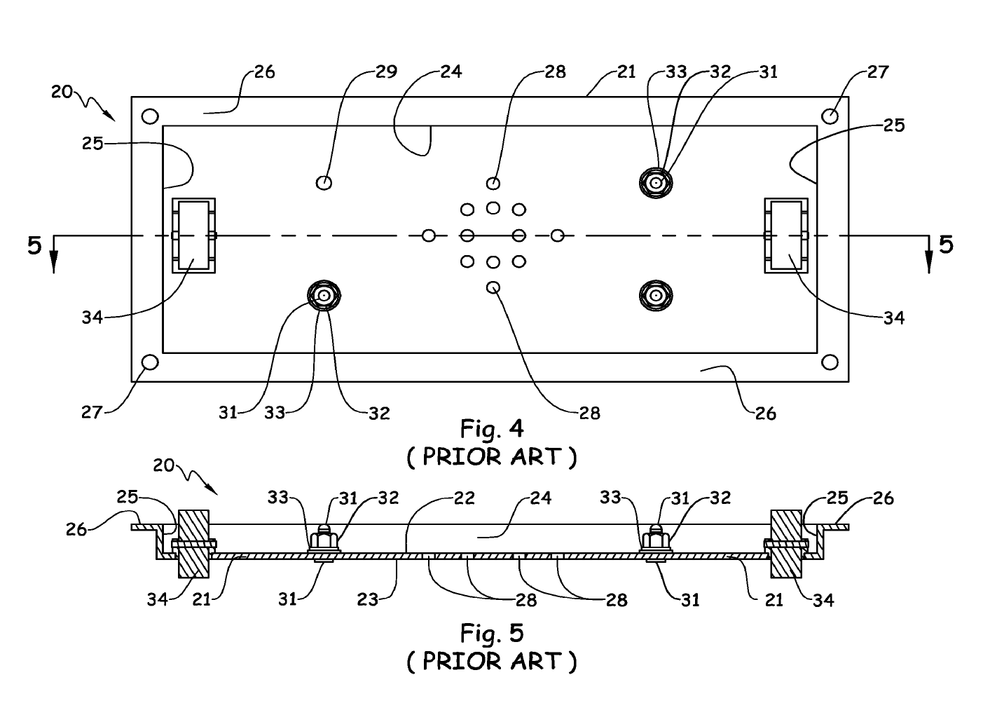

In one embodiment, the repositioning means includes at least first and second wheel members (although not shown in FIGS. 13-18, the wheel members of the present invention may be similar to a conventional wheel members 29 shown in FIGS. 3-5). For example, in one embodiment, the repositioning means includes at least first wheel member removably attached to the first inverted U-shaped channel 130A and at least a second wheel member removably attached to the second inverted U-shaped channel 130B. In addition, the first and second wheel members can be removably mounted to the base plate 100 via insert members 151A and 151B over-molded into the base plate 100 at the first and second inverted U-shaped channels 130A and 130B, respectively. The insert members 151A and 151B are shown in FIGS. 13-16 in an L-shaped configuration, when viewed in cross-section, however, the insert members 151A and 151B are not limited to such L-shaped configuration. For example, the shape of the insert members 151A and 151B, when viewed in cross-section, can be an inverted U-shaped member (or tunnel-like member), an inverted trapezoidal-shaped member, and the like.

For example, in one embodiment, the structural means for moving the refrigerator unit can include (i) a first inverted U-shaped channel forming a tunnel-like member 130A disposed integrally in-between the compressor mounting base plate section 111 and the first reinforcing structure member 120A; (ii) at least first wheel member (not shown) removably attached to the first inverted U-shaped channel 130A; (iii) a second inverted U-shaped channel forming a tunnel-like member 130B disposed integrally in-between the drip tray section 140 and the second reinforcing structure member 120B; and (iv) at least a second wheel member (not shown) removably attached to the second inverted U-shaped channel 130B.

In one preferred embodiment, a first wheel member can be removably attached to the first inverted U-shaped channel 130A and a second wheel member can be removably attached to the second inverted U-shaped channel 130B via a metal insert 151A and 151B, respectively. In one embodiment, the metal insert may be L-shaped members 151A and 151B, when viewed in a side view or cross-section, as shown in FIGS. 13-15. In another embodiment, as shown in FIG. 19, the metal insert may be an inverted U-shaped member 251A and 251B when viewed in a side view or a cross-section view.

The wheels attached to the base plate 100 advantageously provide a means for easily moving the refrigerator with base plate into position for use. The wheels attached to the base plate 100 also advantageously provide a means for easily moving the compressor mounting base plate structure 100 in and out of the refrigerator unit for attachment. One of the at least two wheels is mounted to the base plate 100 at a distal end of the base plate 100 and at least one of the two wheels is mounted to the base plate 100 at a proximal end of the base plate 100.

In yet another embodiment of the compressor mounting base plate of the present invention, a metal insert structure, such as an L-shaped member or a U-shaped member, may be over-molded for wheel mounting on both the proximal and distal ends of the compressor mounting base plate of the present invention. The metal insert can be, for example, 1 mm thickness. The 1 mm thick metal insert facilitates wheel mounting while providing design flexibility and eliminates a secondary operation of piercing holes in the base plate itself.

Generally, in one embodiment of the present invention, the compressor mounting base plate structure is a one-piece composite body made of a non-metal, non-corrosive composite material. For example, the composite material can be a synthetic resin material such as a polyurethane polymer, an epoxy, or a polyester. The composite-based plate body can be made from a synthetic resin matrix binder material and a reinforcement material.

Reinforcement materials suitable for use in producing the compressor mounting base plate structure include a wide variety of materials. Fiber reinforcements are preferred. Fiber materials may be woven, non-woven (random), or combinations thereof.

Suitable reinforcing fibers useful in the present invention for the composition or formulation for constructing the composite body defining the compressor mounting base plate structure may be selected from a group including, for example but not limited to, mineral or ceramic fibers such as Wollastonite, aluminum, glass fibers, carbon fibers and the like; synthetic fibers of nylon, polyester, aramid, polyether ketones, polyether sulfones, polyamides, silicon carbon, and the like; natural fibers such as cellulose, cotton, hemp, flaxes, jute and kanaf fibers; metal fibers; and mixtures thereof. Biocomponent fibers such as a non-glass material spun bonded non-woven having a polyester core and polyamide skin, may also be used.

Glass fiber, either woven or non-woven, such as fiber made from E-glass and S-glass, is the preferred reinforcement material used in the present invention due to its low cost and physical properties. Typically, the reinforcing fibers have an average length of at least 1.00 mm. The reinforcing fibers also typically have a diameter of between about 5 microns and about 20 microns. The fibers may be used in the form of chopped strands or individual chopped filaments.

The matrix binder useful in the present invention for the composition or formulation for constructing the composite body defining the compressor mounting base plate structure may be a thermoset polymer or a thermoplastic polymer. Typically the matrix binder is selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic molding compound, dicyclopentadiene and mixtures thereof. The matrix binder may be used in liquid form, powder form, pellet form, fiber form and/or bi-component fiber form. The physical form of these matrix materials (i.e., their viscosities, particle sizes, etc.) is well-known in the art, variable to be compatible with the particular molding process chosen, and typical of “standard” matrix materials known in the industry.

Generally, the composite body comprises between about 20 weight percent (wt %) and about 50 wt % reinforcing fibers and between about 50 wt % and about 80 wt % matrix binder. The composite body has a density of between about 1.0 g/cm³ and about 2.0 g/cm³.

In one preferred embodiment, a polyurethane composition can be used in the present invention as the synthetic material binder matrix with various reinforcement materials to produce.

There may be several methods for forming the composite formulation by mixing the resin matrix material and the reinforcement material. In addition, the preparation of the binder resin matrix and reinforcement material composition or formulation of the present invention, and/or any of the steps thereof, may be a batch or a continuous process. The mixing equipment used in the process may be any vessel and ancillary equipment well known to those skilled in the art. For example, any known reaction injection machine which capable of mixing and injecting at least a two or more resin system with a pressure of between about 100 bar to about 220 bar can be useful in the preparation of the composite formulation and the final composite product of the present invention.

In general, the composition for fabricating the compressor mounting base plate structure according to an exemplary embodiment of the present invention can be formed by mixing the synthetic resin matrix material and the reinforcement material such as reinforcing fibers arranged in a mold according to an injection process described herein below. That is, the compressor mounting base plate structure may be fabricated by combining the reinforcing fibers with the resin matrix material.

The compressor mounting base plate of the present invention which is useful in refrigerators is preferably made of a synthetic resin through any of the several well known injection molding processes. In the present invention, a most suitable preferred embodiment is to form the compressor mounting base plate structure by using a structural reaction injection molding (S-RIM) process in order to maximize the strength of the compressor mounting base plate structure and reduce the fabrication costs of the compressor mounting base plate structure.

For example, a S-RIM process is an example of a preferred injection molding process that can be used in the present invention to fabricate the compressor mounting base plate in a one-piece body. The S-RIM process uses glass fiber fabrics or mats to make a structurally strong composite. In the S-RIM process, a thermosetting resin is mixed at 100 bar to 220 bar pressure just prior to injection into a hot mold (e.g., 40 degree Celsius [° C.] to 80° C.) containing the fiber reinforcement. The composite mixture solidifies in 30 seconds to 60 seconds into a finished part such compressor mounting base plate.

In the preparation of the composite from the formulation of the present invention, the wetting of the multilayer fibers with a resin system is preferably carried out to avoid fiber delamination. In addition, the conditions of the process should be such that any air entrapment, voids, or bubbles present in the component.

In a preferred embodiment, the S-RIM process is used to produce a compressor mounting base plate structure as a one-piece composite body made of a non-metal, non corrosive composite material. For example, the S-RIM process generally requires the pouring of a liquid thermosetting composition such as a polyurethane into an open or closed mold, which, if open, is subsequently closed during the reaction. Prior to the pouring in of the liquid composition, preferably reinforcing materials and/or reinforcing parts are placed in the open mold. Once the reaction is complete, a compressor mounting base plate article is produced by the S-RIM process. S-RIM processes useful in the present invention are described for example in the following references: U.S. Pat. Nos. 4,457,887; 5,583,197; and 5,686,187; and U.S. Patent Publication No. US20030155687; incorporated herein by reference.

In another preferred embodiment, the compressor mounting base plate structure of the present invention can be made using the S-RIM process and using one or more layers of fiber reinforcement depending on the desired fiber weight. For example, up to 70 percent by volume of the S-RIM compressor mounting base plate structure may comprise reinforcement material. In general, the reinforcing material can be laid directly into the mold and the liquid synthetic resin composition can be poured thereon. Alternatively, or in addition thereto, chopped fibers and other fillers may be added to the composition in amounts up to about 70 percent by volume of the S-RIM compressor mounting base plate structure Preferably, the S-RIM process wherein fiberglass mats are placed in the mold prior to the injection of the synthetic composition is used. Generally, the liquid synthetic resin composition may be applied last, prior to the closing of the mold or the initiation of molding.

Optionally, after the molding of the single S-RIM base plate article, the article can be trimmed. In other uses the molded S-RIM compressor mounting base plate structure article can be used directly as a component for a refrigerator unit.

The resulting compressor mounting base plate structure fabricated the present invention process can have a combination of properties that makes the base plate superior to iron or aluminum for example in a specific strength. For example, the static stiffness of a compressor mounting base plate structure made from steel is typically about 634 N/mm, whereas the static stiffness of the compressor mounting base plate structure according to an exemplary embodiment of the present invention can be about 679 N/mm. In addition, dynamic stiffness of an exemplary embodiment of the present invention can be for example 30 Hz as its first frequency where as for a steel base plate typically the dynamic stiffness is 21 Hz under modal analysis. Accordingly, the base plate of the present invention can have the same strength as that of the existing conventional steel base plate but the weight of the base plate of the present invention can be minimized

In a preferred embodiment, the resin matrix material used in the present invention may be epoxy or polyester in terms of costs and effectiveness. In addition, the reinforcing fibers used in the present invention may be glass fibers which are low-priced and have a suitable strength. In other embodiment, the reinforcing fibers can be other nonmetal fibers such as boron, carbon, graphite, Kevlar, and the like as described above.

In one embodiment of the compressor mounting base plate structure of the present invention, for example as shown in FIGS. 6-19, a S-RIM process is used with a polyurethane resin and a glass fiber reinforcement to form a composite. The thickness for the complete compressor mounting base plate structure can be from about 0.5 mm to about 20 mm in one embodiment; and from about 0.8 mm to about 5 mm in another embodiment.

The polyurethane resin and glass fiber composite material specification for the S-RIM compressor mounting base plate structure includes for example, a Young's Modulus of from about 1.0 GPa to about 100 GPa, and preferably from about 5 GPa to about 40 GPa; a Poisson's ratio of from about 0.01 to about 0.4 and preferably from about 0.1 to about 0.35 and a density of from about 500 Kg/m³ to about 4000 Kg/m³ and preferably from about 800 Kg/m³ to about 2500 Kg/m³.

The composite compressor mounting base plate structure of the present invention also exhibits other advantageous properties. For example, the tensile strength of the base plate can be from about 70 MPa to about 900 MPa in one embodiment; and from about 500 MPa to about 770 MPa in another preferred embodiment, as measured by the test method DIN EN ISO 527.

The flexural modulus of the base plate can be from about 3.5 GPa to about 40 GPa in one embodiment; and from about 10 GPa to about 34 GPa in another preferred embodiment, as measured by the test method DIN EN ISO 178.

Also, the % elongation of the base plate can be from about 1% to about 7% in one embodiment; and from about 1% to about 2.5% in another preferred embodiment, as measured by the test method DIN EN ISO 527.

Base plates made of polyurethane composite material exhibits better/excellent damping properties over base plates made of steel, providing vibration absorption characteristics transmitted by a compressor. For example, the damping increase of a composite material of the present invention base plate over steel is generally from about 50% to about 900% in one embodiment, and from about 300% to about 700% in another embodiment.

The composite product which is a thermoset product (i.e. a cross-linked product made from the formulation) of the present invention shows several improved properties over conventional epoxy cured resins.

For example, the composite product of the present invention may have a glass transition temperature (Tg) generally from about 80° C. to about 150° C. in one embodiment; from about 100° C. to about 120° C. in another embodiment; The Tg may be measured using a differential scanning calorimeter by scanning at 10° C./minute. The Tg is determined by the inflection point of the 2^{nd} order transition.

The composite system of the present invention is used to prepare a compressor mounting plate for a refrigerator.

The compressor mounting base plate structure of the present invention is advantageously used in a refrigerator unit wherein the base plate structure is installed in the machine compartment of the refrigerator. To achieve the advantages in accordance with the purpose of the present invention, as embodied and broadly described herein, in general, there is provided a refrigerator including: (a) a refrigerator main body having a cooling chamber for storing foods; (b) a machine compartment; (c) a compressor mounting base plate structure installed in the machine compartment located at a lower portion of the refrigerator main body; said compressor mounting base plate structure adapted for receiving and supporting a compressor; and (d) a compressor mounted on the compressor mounting base plate structure. The compressor mounting base plate structure engages the machine compartment forming the bottom structure of the machine compartment casing and together with the lower portion of the refrigerator main body, the top surface of the base plate defines the machine compartment of the refrigerator.

Generally, a refrigerator is comprised of: a main body having a cooling chamber such as a freezing chamber and a refrigerating chamber therein; and a machine compartment positioned at a lower portion of a rear side of the main body and having various components forming a refrigeration cycle such as a compressor for compressing a refrigerant. Other parts of the refrigerator may include, for example, a control box for controlling the refrigeration cycle installed inside of the machine compartment and a separate water tray installed inside of the machine compartment for storing water generated from the refrigeration cycle by a defrosting operation.

The compressor mounting base plate structure of the present invention is mounted on a lower bottom portion of the machine compartment; and a compressor is mounted on the compressor mounting base plate structure. The compressor mounting base plate structure is affixed to the lower portion of the main body by any attachment which can be removable such as mounting brackets and one or more nuts and bolts.

In the present invention, the compressor can be installed on the compressor mounting base plate structure by mounting bracket system including a support bracket, a vibration preventing rubber member removably attached to the mounting bracket for preventing vibration generated from the compressor from being transferred to the main refrigerator body; and nuts and bolts to firmly affix the compressor to the base plate structure.

When the refrigerator containing the compressor mounting base plate structure of the present invention is constructed and operated as aforementioned the improved described above can be achieved.

### EXAMPLES

The following comparative example and example further illustrate the present invention in detail but are not to be construed to limit the scope thereof.

### Comparative Example A

The geometry of a conventional steel compressor mounting base plate has rectangular section tray member as shown in FIGS. 3-5 and the geometry is generated using Computer-Aided Design (CAD) tools, CATIA™. This prior art base plate is made from 1 mm thick stamped steel sheets. The steel base plate has overall dimension as approximately 530 mm in length, 190 mm in width and 35 mm as its height. The steel prior art compressor mounting base plate weighs about 1.3 kg which includes plastic drip tray. The geometry of the steel base plate is loaded into a finite element meshing (FEM) tool, Hypermesh™. Typical mild steel properties considered as material properties, such as Young's modulus, Density and Poisson's ratio and boundary conditions are considered to develop a model. The model generated from Hypermesh™ is loaded in solver OPTISTRUCT version 11.0 to resolve the force of magnitude 95 Newton as the compressor mass to be acted upon the base plate, which is applied at the center of gravity of compressor. The finite element results for steel base plate prior art showed displacement of 0.15 mm and its corresponding base plate stiffness is calculated to be 633 N/mm. The dynamic finite element modal analysis provided first frequency of 21 Hz under the same boundary condition utilized for stiffness calculation.

### Example 1

An example of a fiber-reinforced composite of an elongated non-metal, non-corrosive compressor mounting base plate structure for a refrigerator unit in accordance with the present invention is as follows:

A. Formulation

Polyol 100 pbw (part by weight) is mixed with isocynite 140-150 pbw in a high pressure reaction injection machine and injected at a pressure of 180 bar inside a closed mold with 60% volume of glass fibre.

B. S-RIM Procedure

A fiber-reinforced composite compressor mounting base plate was prepared using S-RIM process as follows:

Woven bi-directional glass fibre cut to shape of the sample of the part. The woven glass fibre mat is placed inside the mold with 0, +45, −45 orientations. The injection point of the gate, the gate is positioned in such a way that the glass mat orientation is not disturbed with high pressure injection. The mold is heated at 65° C. with the temperature difference of 5° C. on top and bottom of the mold which enables uniform and faster curing across thickness of the component. A polyurethane system created by a high pressure mix of polyol-isocynite is injected into the mold to create a polyurethane composite compressor mounting base plate.

C. Results

The structure of a polyurethane composite compressor mounting base plate of the present invention is shown in FIGS. 13-18. The composite compressor mounting base plate 100, in the form of a base plate tray member 100, includes a means for receiving and affixing compressor to the base plate member 111. On the perimeter of the top surface of the base plate has vertical sidewalls 114 having height approximately 27 mm. The rectangular shaped base plate have integral vertical sidewall members 115 with approximate height of 30 mm in plane perpendicular to base plate. The reinforcement in terms of woven glass fiber mat is laid out in members forming first tray for increased strength and rigidity. The Young's modulus of reinforced area is 35 GPa with density of 2000 kg/m3.

A drip tray member 140 is integral with the base plate member 111; wherein the drip tray member 140 comprises vertical sidewalls 144 integral with the first base plate member on the top surface 112 of the base plate member 111. The sidewall of the drip tray has height of approximately 70 mm. The drip tray member has polyurethane material with Young's modulus of 4000 GPa and density as 1100 kg/m³.

The polyurethane composite compressor base plate 100 has overall dimensions of approximately 530 mm in length, 200 mm in width and 27 mm in height and thickness of this part is 2.5 mm. This inventive polyurethane composite base plate with above details weighs about 0.95 kg. The geometry of the composite base plate is loaded into a finite element meshing (FEM) tool, Hypermesh™. Material properties, such as Young's Modulus, density and Poisson's Ratio and boundary conditions are considered to develop a model. The model generated from Hypermesh™ is loaded in solver OPTISTRUCT version 11.0 to resolve the force of magnitude 95 Newton as the compressor mass to be acted upon the base plate, which is applied at the center of gravity of compressor. The finite element result exhibits maximum displacement of 0.14 mm and base plate stiffness is calculated to be 678 N/mm. The stiffness of present invention composite compressor base plate signifies equal strength as of the prior art steel base plate. The dynamic finite element modal analysis provided first frequency of 30 Hz under the same boundary condition utilized for stiffness calculation, demonstrating the present invention base plate had an improved dynamic stiffness over a prior art steel base plate. The performance of the polyurethane composite compressor mounting base plate of the present invention is the same or better than a conventional steel base plate with 27% reduced mass which indicates the present invention base plate has a lighter design.

1. An elongated non-metal, non corrosive-compressor mounting base plate structure comprising:
(I) a base plate segment having a top surface and a bottom surface, said base plate segment further comprising four vertical sidewalls disposed perpendicular to the horizontal plane of the base plate and integral with the base plate segment, one vertical sidewall disposed on each of the four sides of the base plate segment and along the perimeter of the top surface of the base plate segment forming a base plate tray member; wherein the base plate segment is adapted for receiving a compressor on the top surface of the base plate segment within the area of the base plate segment surrounded by the four vertical sidewalls;
(II) a means for receiving and removably affixing a compressor to the top surface of the base plate segment; and
(III) a reinforcement means integral with said base plate segment; wherein said reinforcement means includes at least two elongated transverse reinforcement segments integral with the base plate segment, one transverse reinforcement segment at each of the transverse sides of the base plate segment; said reinforcement means being adapted for providing the compressor mounting base plate structure with sufficient strength and rigidity such that the compressor mounting base plate structure can withstand deformation a load from the weight of the compressor; and
wherein the compressor mounting base plate structure comprises a non-metal, non corrosive structure.

2. The compressor mounting base plate structure of claim 1, including (IV) at least one load bearing/load distributing structure adapted for providing strength, reinforcement and integrity to the mounting base plate structure integral with the base plate.

3. The compressor mounting base plate structure of claim 2, wherein the at least one load bearing/load distributing structure is a raised surface area in at least a portion of the base plate segment adapted for receiving a compressor.

4-6. (canceled)

7. The compressor mounting base plate structure of claim 1, wherein the reinforcement means (III) comprises at least a first reinforcing structure member integral with the base plate at a proximal end of the base plate; and at least a second reinforcing structure member integral with the base plate at a distal end of the base plate.

8. The compressor mounting base plate structure of claim 4, wherein the at least first reinforcing structure member comprises a first U-shaped channel when viewed in cross-section, and disposed at one transverse end of and integral with the base plate; wherein the first U-shaped channel includes sidewalls at both ends of the U-shaped channel forming a first elongated U-shaped trough member; and wherein the second reinforcing structure member comprises a second U-shaped channel, when viewed in cross-section, and disposed at the other transverse end of and integral with the base plate; wherein the second U-shaped channel includes sidewalls at both ends of the U-shaped channel forming a second elongated U-shaped trough member.

9. The compressor mounting base plate structure of claim 4, wherein the at least first and second reinforcing structure members comprise a V-shaped channel when viewed in cross-section.

10-15. (canceled)

16. The compressor mounting base plate structure of claim 4, wherein the at least first reinforcing structure member comprises a first solid elongated bar or rib member disposed at one transverse end of and integral with the base plate; and wherein the second reinforcing structure member comprises a second solid bar or rib disposed at the other transverse end of and integral with the base plate.

17. The compressor mounting base plate structure of claim 5, wherein the first elongated U-shaped channel trough member, the second elongated U-shaped channel trough member, or both comprise a solid elongated U-shaped bar or rib integral with the base plate.

18-23. (canceled)

24. A process for manufacturing a compressor mounting base plate structure composite comprising subjecting a composite material to an open mold or a closed mold Structural Reaction Injection Molding (S-RIM) process to form a one piece compressor mounting base plate structure of claim 1.

25. An appliance device which uses a compressor, a motor, or an equivalent vibrating (reciprocating/rotating) apparatus comprising the compressor mounting base plate structure of claim 1.

26. (canceled)

27. A refrigerator, comprising:
(a) a refrigerator main body having a cooling chamber for storing foods and a machine room;
(b) a compressor mounting base plate structure of claim 1 installed in the machine room located at a lower portion of the refrigerator main body; said compressor mounting base plate structure adapted for receiving and supporting a compressor; and
(c) a compressor mounted on the mounting base plate structure.
